(19) United States
(12) Patent Application Publication
(10) Pub. No.: US 2011/0042117 A1
(43) Pub. Date: Feb. 24, 2011

(54) ENERGY STORAGE MODULE AND POWER TOOL COMPRISING AT LEAST ONE ENERGY STORAGE MODULE

(76) Inventors: Volker Doege, Dischingen (DE); Cornelius Liebenow, Leinfelden-Echterdingen (DE); Rainer Glauning, Leinfelden-Echterdingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/736,600

(22) PCT Filed: Dec. 4, 2008
(86) PCT No.: PCT/EP2008/066790

§ 371 Date: Nov. 5, 2010

(30) Foreign Application Priority Data
Apr. 21, 2008 (DE) 10 2008 001 286.6

(51) Int. Cl. H01M 2/10; H01M 2/12; H01M 10/42; B25F 3/00

(52) U.S. Cl. 173/217; 429/159; 429/82; 429/7

(57) ABSTRACT

The invention is based on an energy storage module, in particular a battery pack for supplying power to a power tool. According to the invention, a plurality of cells are interconnected electrically for energy storage. It is proposed that the cells are electrochemical storage cells having a flexible cell casing that is dimensionally unstable. The invention further relates to a power tool having at least one such energy storage module.

### PRIOR ART

The invention is based on an energy storage module and on a power tool equipped with at least one energy storage module with the defining characteristics of the preambles to the independent claims.

Batteries that are known from the market and provided for cordless power tools contain energy storage modules embodied in the form of electrochemical storage cells with a round form factor and a rigid, stable metal cup that also constitutes one of the two electrical poles of the cell. As a rule, these are NiCd, NiMH, or lithium ion cells. In addition to the components required for energy storage, the metal cup of these cells often also contains additional protective components intended to ensure the safety of the cell in the event of an overload or short-circuit and in the event of exposure to high temperatures. Typical examples of these include safety valves and so-called “current-interruption devices”.

Known battery packs for power tools also contain additional safety elements situated outside the cells, for example fuses or electronic protection circuits, cell connectors, contact surfaces, insulation materials, and suitably shaped parts that fix the round cells in the provided positions inside the usually block-shaped battery packs.

With the known use of circular cells, the available space in the battery pack is not fully exploited. Since each cell contains its own protective components, this increases the amount of space required per cell used and increases the total volume of the battery pack. Since the round cells must once again be individually fixed in position in the battery pack with a holding device, in addition to the heavy metal packaging of the individual cells, yet another component is required that partially encompasses the cells and further increases the total volume of the battery pack. The increase in volume and material required results in a significant reduction in the volumetric and specific energy density of the known battery packs in comparison to the values predetermined by the individual cells.

The object of the invention is to embody an energy storage module that on the one hand has an optimum ratio of volume, weight, and/or required material/parts to the energy that can be stored with the energy storage module and on the other hand, is as safe as possible.

### DISCLOSURE OF THE INVENTION

The invention is based on an energy storage module, in particular a battery pack for supplying power to a power tool, equipped with a plurality of cells for energy storage that are electrically connected to one another. As proposed by the invention, the cells are electrochemical storage cells with flexible cell casings. The cell casings are intrinsically not dimensionally stable (dimensionally unstable). In comparison to known energy storage modules, the elimination of metal cell cups and various safety elements for each individual cell achieves savings in weight and material in comparison to the stored energy. In addition, storage cells without hard casings can be embodied in a simple, flat form and in particular, can be block-shaped. Block-shaped or almost block-shaped cells make it possible to exploit the available space in the energy storage module better than round cells. This permits a space-saving design of a block-shaped energy storage module with minimal intermediate gaps, without impairing its function. By means of electrical contacts that extend as necessary through walls of any cell housings provided, the cells can exchange electrical energy with a consumer, in particular the power tool, or with a charger.

In an advantageous embodiment, the cells can be arranged in stacks and connected in series, in parallel, or in a combination of series and parallel circuits. Cell stacks can be accommodated in a simple, space-saving way in a block-shaped housing of the energy storage module.

In another preferred variant, the cells can be polymer cells, in particular lithium ion polymer cells or lithium polymer cells; it is also conceivable for them to be cells in which an electrode stack or an electrode coil is provided with a separator that is impregnated with an electrolyte solution and packed in a gas-tight fashion with a flexible, non-rigid material.

Advantageously, the cells can be arranged individually or in groups in a hard, preferably block-shaped cell container or an open casing. In this way, the cell container fixes the cells in a definite position in relation to one another, possibly through installation of individual compartments, each for one or more respective cells. In addition, the cell container encompasses the cells or cell stack completely and separates it from the surroundings in a sufficiently gas-tight fashion. The cell container with the cells fixed in place therein can then be simply installed into the energy storage module and electrically connected. The cell container can be composed of metal, plastic, or a combination of metal and plastic. One wall of the cell container can have passages for the electrical contact of the cells for the consumers or the charger. An open casing is lighter than a closed cell container and does not require passages to be provided for the electrical contacts. A plurality of cell containers can be combined to form a module housing of the energy storage module.

The cell container can advantageously be at least partially composed of an in particular flame-retardant, heat-resistant plastic. Plastic housings are light, easy to manufacture, and as a rule, electrically insulating.

The cell container can advantageously have at least one overpressure protection means, in particular a pressure relief valve and/or a predetermined breaking point. An overpressure in the cell container, which can arise, for example, due to overheating, can thus be reduced in a controlled fashion and the risk of explosion is reduced.

In another advantageous embodiment, the cell container can have at least one electrical/electronic protection means, in particular a temperature sensor and/or a current-interruption device, preferably a fuse. As with the overpressure protection means, the electrical/electronic protection means permits implementation of an optimum protection of the energy storage module in operating states whose occurrence indicates a danger, particularly to a user. Such dangerous operating states particularly include an overloading of the cells as well as a discharging of the energy storage module with an excessively high current. In addition, the protection means provide protection from an excessive loading of the cells contained in the energy storage module and the resulting faster aging of the energy storage module. In particular, the protection means provide protection from the discharge of excessively high currents. They likewise provide protection of the energy storage module from an operation at excessive (ambient) temperatures. Moreover, when excessive heat occurs in the cell container, particularly due to the dissipation of heat from the cells, the protection means can prevent the flow of current into and out of the cells.

In another advantageous embodiment, the cell container can have at least one electrical/electronic protection means and at least one overpressure protection means that functionally cooperate with each other. In this way, when the overpressure protection means is triggered, the electrical/electronic protection means also simultaneously interrupts the flow of current. This significantly increases the safety of the energy storage module.

A power tool according to the invention has at least one such energy storage module or a similar one, in particular a battery pack for supplying power to a power tool, equipped with a plurality of cells; the cells are electrochemical storage cells with flexible cell casings that are intrinsically not dimensionally stable (dimensionally unstable). The cells can advantageously be polymer cells that can easily be embodied as block-shaped or in an almost block-shaped form, which has a positive effect on the ratio of the volume/weight to the energy that can be stored with the energy storage module.

### BRIEF DESCRIPTION OF THE DRAWINGS

Drawings

Other advantages ensue from the following description of the drawings. The drawings show exemplary embodiments of the invention. The person of ordinary skill in the art will also consider the features disclosed in combination in the drawings, the description, and the claims individually and will unite them in other meaningful combinations.

FIG. 1 is a schematic, isometric depiction of a battery pack with three block-shaped polymer cells, each contained in a respective cell container, according to a first exemplary embodiment;

FIG. 2 is a schematic, isometric depiction of one of the cell containers with a polymer cell from FIG. 1;

FIG. 3 is a schematic side view of the cell container with the polymer cell from FIG. 2;

FIG. 4 is a schematic top view, with a partial section through the cell container with the polymer cell from FIGS. 2 and 3;

FIG. 5 is a schematic, isometric depiction of a battery pack similar to the one in FIG. 1, with six block-shaped polymer cells in two cell containers, according to a second exemplary embodiment;

FIG. 6 is a schematic, isometric depiction of one of the cell containers with three polymer cells from FIG. 5.

### EMBODIMENT OF THE INVENTION

FIG. 1 shows a first exemplary embodiment of an energy storage module in the form of a battery pack 10 for supplying power to a preferably cordless power tool, not shown.

To supply energy, this battery pack 10 has three block-shaped lithium-ion cells or lithium cells electrically connected to one another (referred to below for short as polymer cells 12), which are embodied using the so-called polymer technique, for example in the form of pouch cells, laminated-type cells, or lithium (ion) polymer cells, and are not encompassed by a rigid (metal) casing like conventional lithium (ion) cells, but rather with a flexible, soft cell casing that is intrinsically not dimensionally stable.

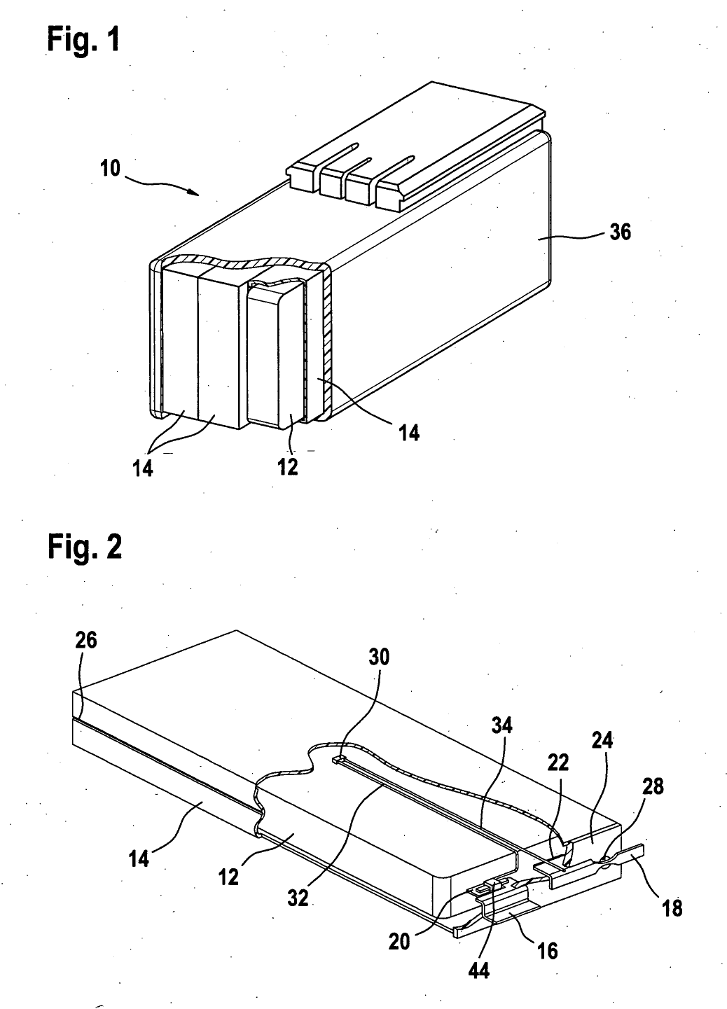

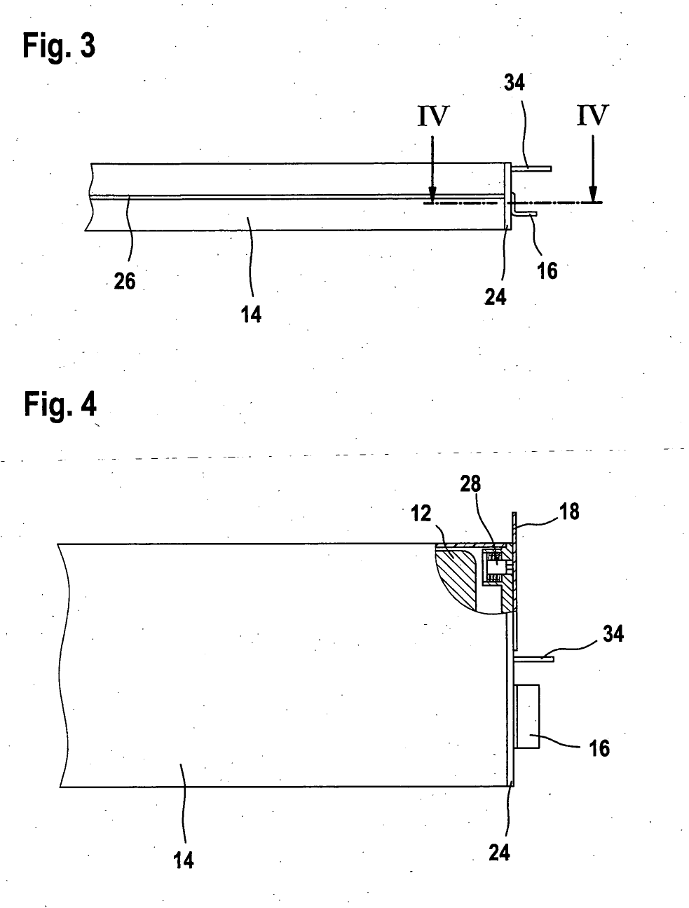

The soft polymer cells 12 are situated in dimensionally stable cell containers 14 that are described in greater detail below, one of which is depicted with the polymer cell 12 contained therein in the details shown in FIGS. 2 through 4.

Each polymer cell 12 preferably has one positive electrode that is hidden in FIGS. 1 through 4 and contains pure or mixed oxides of nickel, cobalt, manganese, or other transition metal phosphates such as iron phosphates, manganese phosphates, or cobalt phosphates, or mixtures of the two substance classes. A negative electrode of the polymer cell 12 either contains substances that can store lithium ions when the polymer cell 12 is charged, e.g. carbon materials, or contains special alloys, metallic lithium, or alloys thereof.

The polymer cells 12 can be connected to one another both in series and in parallel; it is also possible to implement a combination of parallel and serial electrical interconnection.

The polymer cells 12 are each individually installed in one of the respective dimensionally stable cell containers 14. The cell containers 14 are composed of a plastic that is fire-retardant and heat-resistant. The cell container 14 encompasses the polymer cell 12 completely and separates it from the surroundings in a sufficiently gas-tight fashion.

On a connecting side of the cell container 14, on the right side in FIGS. 2 through 4, two connection contacts 16 and 18 extend from the respective electrode poles 20 and 22 of the polymer cell 12 through a cover 24 of the cell container 14 to the outside of the cell container 14. Only the back sides opposite from the connection sides of the cell containers 14 are visible in FIG. 1.

A fuse 44 for interrupting the electrical connection is situated between one of the electrode poles 20 of the polymer cell 12 and the corresponding connecting contact 16 on the left in FIG. 2.

The cell container 14 contains a suitable predetermined breaking point 26 in the form of a notch in the cell container material, which can burst in the event of an excessive pressure increase inside the cell container 14. This ensures that the cell container 14 will open at this desired predetermined breaking point 26 if the internal pressure inside the cell container 14 exceeds a certain value.

In addition, the cell container 14 is equipped with a reversibly opening, spring-prestressed pressure relief valve 28 that reacts even at low internal pressures inside the cell container 14.

The cell container 14 also contains a temperature sensor 30 with a negative temperature coefficient (NTC). The temperature sensor 30 is situated between a large surface of the cell container 14 and the polymer cell 12. It is connected via a first connecting line 32 to the connection of the fuse 44 oriented away from the electrode pole 20 of the polymer cell 12. A second connecting line 34 extends through the cover 24 of the cell container 14 and on the outside of the cell container 14, constitutes a temperature sensor contact. Optionally, a recess (not shown) in the container wall can accommodate the temperature sensor 30 so that it is prevented from slipping and does not exert localized pressure on the polymer cell 12.

The temperature sensor contact is in turn connected to an electronic circuit, not shown, that is integrated into the battery pack 10 and can be used to detect the resistance value of the temperature sensor 30.

Three such cell containers 14 with polymer cells 12 fixed in position inside them are in turn components of the battery pack 10 as a whole and for this purpose, are installed into a block-shaped module housing 36 of the battery pack 10 and then electrically connected to one another (FIG. 1). The three cell containers 14 are stacked in succession so that their large surfaces face one another.

In addition to the cell containers 14 filled with the polymer cells 12, the battery pack 10 contains additional mechanical and electrically acting components, not shown in FIG. 1, e.g. electrical contacts, cable, insulation material or the like, or also an electronic protection circuit.

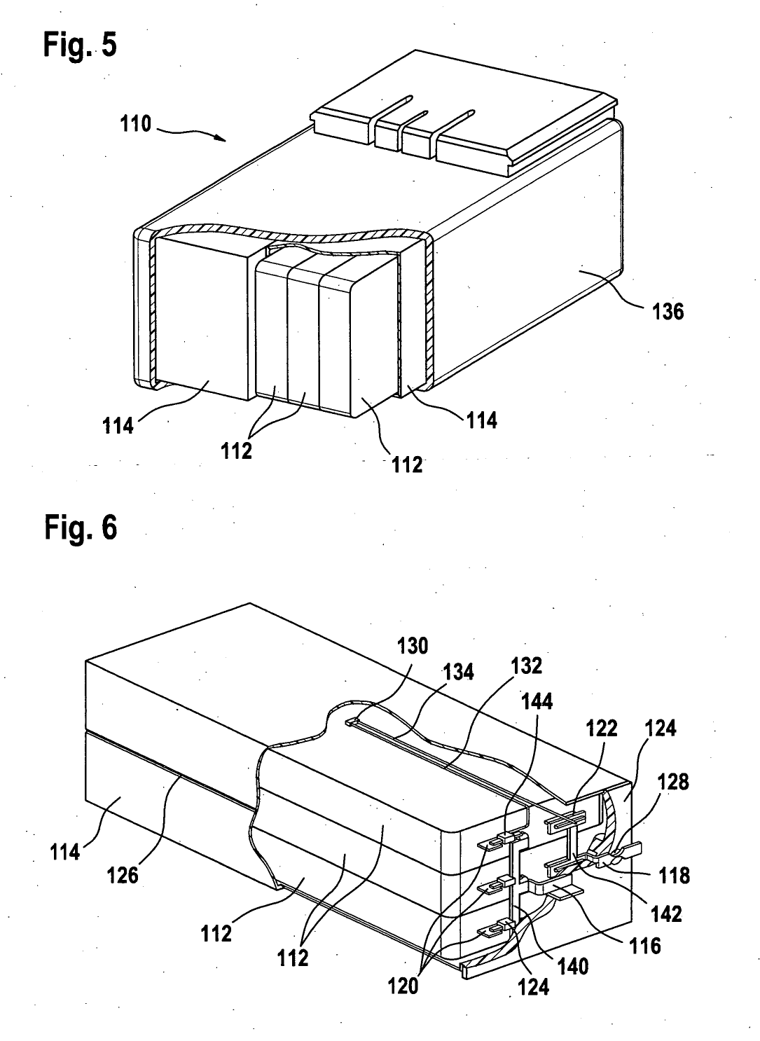

In a second exemplary embodiment depicted in FIGS. 5 and 6, those elements that are similar to ones in the first exemplary embodiment described in conjunction with FIGS. 1 through 4 have been provided with the same reference numerals increased by 100; with regard to their description, the reader is referred to the explanations relating to the first exemplary embodiment. This second exemplary embodiment differs from the first in that each cell container 114 contains three polymer cells 112 that are electrically connected in parallel and stacked in succession so that the large surfaces of the polymer cells 112 face one another. For example, two-such cell containers 114 are combined in a module housing 136 of an energy storage module.

The cell container 114 fixes the polymer cells 112 in a definite position relative to one another. The cell container 114 encompasses the cell stack of polymer cells 114 completely and separates the cell stack from the surroundings in a sufficiently gas-tight fashion.

The electrical connection between the electrical poles 120 and 122, respectively, of the individual polymer cells 112 is carried out by means of bridges 140 and 142 inside the cell container 114. A fuse 144 for interrupting the electrical connection is provided between each electrode pole 120 of each polymer cell 112 and the corresponding bridge 140, on the left in FIG. 6.

From each bridge 140 and 142, the respective connecting contact 116 and 118 extends through the cover 124 to the outside of the cell container 114.

In a third variant of the invention, not shown here, instead of being implemented by means of the cell container 14; 114, a fixing of the polymer cells 12; 112 can also be implemented by means of a metal or plastic casing that only partially encloses the polymer cell 12; 112 or cell stack and does not insulate the polymer cells 12; 112 in a gas-tight fashion in relation to the surroundings. Here, too, the polymer cell ensemble, which is composed of the polymer cells 12; 112 and the metal or plastic casing used to fix them in place and provide them with a flame-retardant shield, is installed in a battery pack 10; 110 composed of additional components.

In all of the above-described exemplary embodiments of a battery pack 10; 110; the following modifications, among others, are possible:

Instead of being lithium (ion) cells, the polymer cells 12; 112 can also be other types of electrochemical storage cells without rigid cell containers.

Instead of being block-shaped, the polymer cells 12; 112 can also be embodied in a different shape, for example with a base and top that are triangular or in the shape of another polygon.

It is also possible for two or more than three polymer cells 12; 112 to be contained in a cell container 14; 114 and/or for less than two or more than three cell containers 14; 114 with polymer cells 12; 112 therein to be combined in one battery pack 10; 110.

Particularly in the second exemplary embodiment, the electrical connection of the individual polymer cells 112 to one another can also be produced outside the cell container 114 in lieu of being produced inside the cell container 114.

Particularly in the second exemplary embodiment, the polymer cells 112 can be fixed in a definite position in relation to one another in the cell container 114 by installing individual compartments, each intended, for example, for one or two polymer cells 112.

Instead of being made of plastic, the cell containers 14; 114 can also be made of metal. When the cell container 14; 114 is constructed of a metallic material, then it can be coated with an insulating layer composed of a plastic material.

In cell containers 14; 114 composed of plastic, the plastic can be reinforced by incorporating metal components into it in order to improve the mechanical stability. These components can be embodied so that they inhibit or entirely prevent the penetration of sharp objects. It is likewise possible to provide the plastic with metallic or nonmetallic additives that improve the thermal conductivity of the plastic.

The cell containers 14; 114 composed of plastic can additionally or alternatively also have flame-retardant components added to them.

The predetermined breaking points 26; 126 of the cell containers 14; 114 can also have a plurality of notches.

Instead of being provided with the spring-prestressed, reversibly opening pressure relief valve 28; 128, each cell container 14; 114 can also be equipped with a different, also irreversibly opening pressure relief valve.

Each cell container 14; 114 can be equipped with additional safety elements such as a current-interrupting device, which prevents the flow of current through the polymer cells 12; 112 in certain safety-critical situations, for example in the event of an excessive current, in particular a short-circuit current, or upon occurrence of high temperatures.

Through suitable structural measures and conductor routing, the occurrence of an opening of the predetermined breaking point 26; 126 of the cell container 14; 114 can be combined with an interruption of the current supply to the battery pack 10; 110. For example, an electrical feed line or outgoing feeder can be integrated into or affixed to the predetermined breaking point 26; 126 of the cell housing wall so that it breaks at the same time as the predetermined breaking point 26; 126, thus disconnecting the electrical connection at this location.

Instead of being detected by the electronic circuit integrated into the battery pack 10; 110, the resistance value of the temperature sensor 30; 130 can also be detected by the electronics of a contacted charger and/or the power tool via a corresponding contact on the battery pack 10; 110.

In addition to or alternatively to the temperature sensors 30; 130 in the cell containers 14; 114, the battery pack 10; 110 can contain a temperature sensor whose resistance value can be detected via contacts on the battery pack 10; 110, either by the electronics of the contacted charger or power tool or by the electronic circuit integrated into the battery pack 10; 110.

Instead of the temperature sensors 30; 130 with NTC, it is also possible to use different temperature sensors, for example ones with a positive temperature coefficient (e.g. Pt100).

Where necessary, an electronic individual cell monitoring or a monitoring of intermediate voltages can be carried out in the battery pack 10; 110; this monitoring communicates with the connected charger or power tool via an interface and when an overvoltage or undervoltage is detected, respectively stops the charger from supplying current or stops the power tool from drawing current.

1-9. (canceled)

10. An energy storage module, embodied as a battery pack for supplying power to a power tool, the energy module comprising a plurality of cells for energy storage that are electrically connected to one another, the cells being electrochemical storage cells with a flexible casing that is intrinsically dimensionally unstable.

11. The energy storage module as recited in claim 10, wherein the cells are arranged in stacks and connected in series, in parallel, or in a combination of series and parallel circuits.

12. The energy storage module as recited in claim 10, wherein the cells are polymer cells, in particular lithium ion polymer cells or lithium polymer cells.

13. The energy storage module as recited in claim 11, wherein the cells are polymer cells, in particular lithium ion polymer cells or lithium polymer cells.

14. The energy storage module as recited in claim 10, wherein the cells are arranged individually or in groups in a hard, preferably block-shaped cell container, or in an open casing.

15. The energy storage module as recited in claim 11, wherein the cells are arranged individually or in groups in a hard, preferably block-shaped cell container, or in an open casing.

16. The energy storage module as recited in claim 12, wherein the cells are arranged individually or in groups in a hard, preferably block-shaped cell container, or in an open casing.

17. The energy storage module as recited in claim 14, wherein the cell container is at least partially composed of an in particular flame-retardant, heat-resistant plastic.

18. The energy storage module as recited in claim 15, wherein the cell container is at least partially composed of an in particular flame-retardant, heat-resistant plastic.

19. The energy storage module as recited in claim 16, wherein the cell container is at least partially composed of an in particular flame-retardant, heat-resistant plastic.

20. The energy storage module as recited in claim 14, wherein the cell container has at least one overpressure protection device, embodied as a pressure relief valve and/or a predetermined breaking point.

21. The energy storage module as recited in claim 17, wherein the cell container has at least one overpressure protection device, embodied as a pressure relief valve and/or a predetermined breaking point.

22. The energy storage module as recited in claim 14, wherein the cell container has at least one electrical/electronic protection device, embodied as a temperature sensor and/or a current-interruption device, preferably a fuse.

23. The energy storage module as recited in claim 17, wherein the cell container has at least one electrical/electronic protection device, embodied as a temperature sensor and/or a current-interruption device, preferably a fuse.

24. The energy storage module as recited in claim 20, wherein the cell container has at least one electrical/electronic protection device, embodied as a temperature sensor and/or a current-interruption device, preferably a fuse.

25. The energy storage module as recited in claim 14, wherein the cell container has at least one electrical/electronic protection device and at least one overpressure protection device that functionally cooperate with each other.

26. The energy storage module as recited in claim 17, wherein the cell container has at least one electrical/electronic protection device and at least one overpressure protection device that functionally cooperate with each other.

27. The energy storage module as recited in claim 20, wherein the cell container has at least one electrical/electronic protection device and at least one overpressure protection device that functionally cooperate with each other.

28. The energy storage module as recited in claim 22, wherein the cell container has at least one electrical/electronic protection device and at least one overpressure protection device that functionally cooperate with each other.

29. A power tool having at least one energy storage module, embodied as a battery pack for supplying power to a power tool, the energy storage module being equipped with a plurality of cells that are electrically connected to one another, in particular as recited in claim 10, wherein the cells are electrochemical storage cells with a flexible casing that is intrinsically dimensionally unstable.
